(19) United States
(12) Patent Application Publication
(10) Pub. No.: US 2008/0231190 A1
(43) Pub. Date: Sep. 25, 2008

(54) PLASMA DISPLAY DEVICE, AND METHOD FOR MANUFACTURING THE SAME

(75) Inventor: KI-DONG KIM, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/050,356

(22) Filed: Mar. 18, 2008

(30) Foreign Application Priority Data
Mar. 21, 2007 (KR) 10-2007-0027726

(51) Int. Cl. H01J 17/49; H01J 9/00

(52) U.S. Cl. 313/587; 445/24

(57) ABSTRACT

The present invention relates to a plasma display device including a plasma display panel comprising an address electrode disposed on a first substrate, a pair of first and second display electrodes disposed on the second substrate and crossing address electrode, a dielectric layer covering the first and second display electrodes on the second substrate, an MgO protective layer covering the dielectric layer on the second substrate, discharge gases filled between the first and second substrates, a driver for driving the plasma display panel, and a controller for controlling the driver so that a sustain pulse width of a sustain period may be 1 to 3.5 μs. The MgO protective layer comprises MgO that has a grain size of 100 to 300 nm. The high-definition plasma display device according to one embodiment of the present invention has improved response speed and discharge stability by adjusting the statistical delay time.

### CROSS-REFERENCE TO RELATED APPLICATIONS

This application claims the benefit of Korean Application No. 2007-27726 filed Mar. 21, 2007, in the Korean Intellectual Property Office, the disclosure of which is incorporated herein by reference.

### BACKGROUND OF THE INVENTION

1. Field of the Invention

Aspects of the present invention relate a plasma display device and a method of manufacturing the same. More particularly, aspects of the present invention relate to a plasma display device that has an improved response speed and discharge stability due to a reduced statistical delay time.

2. Description of the Related Art

A plasma display panel is a display device that forms an image by exciting phosphor with vacuum ultraviolet (VUV) rays generated by gas discharge in discharge cells.

A plasma display panel displays text and/or graphics by using light emitted from plasma that is generated by the gas discharge. An image is formed by applying a predetermined level of voltage to two electrodes situated in a discharge space of the plasma display panel to induce plasma discharge between the two electrodes and exciting a phosphor layer that is formed in a predetermined pattern by ultraviolet rays generated from the plasma discharge. (The two electrodes situated in the discharge space of the plasma display panel are hereinafter referred to as the “display electrodes.”)

Generally, the plasma display panel includes a dielectric layer that covers the two display electrodes and a protective layer on the dielectric layer to protect the dielectric layer. The protective layer is mainly composed of MgO, which is transparent to allow the visible light to permeate and which exhibits excellent protective performance for the dielectric layer and also produces secondary electron emission. Recently, however, alternatives and modifications for the MgO protective layer have been researched.

The MgO protective layer has a sputtering resistance characteristic that lessens the ionic impact of the discharge gas upon the discharge while the plasma display device is driven and protects the dielectric layer. Further, an MgO protective layer in the form of a transparent protective thin film reduces the discharge voltage through emitting of secondary electrons. Typically, the MgO protective layer is coated on the dielectric layer in a thickness of 5000 to 9000 Å.

Accordingly, the components and the membrane characteristics of the MgO protective layer significantly affect the discharge characteristics. The membrane characteristics of the MgO protective layer are significantly dependent upon the components and the coating conditions of deposition. It is desirable to develop optimal components for improving the membrane characteristics.

It is desirable to improve the discharge stability of the high-definition plasma display panel (PDP) through an improvement of the response speed. The high-definition plasma display panel should respond to a rapid scan speed such that a stable discharge in which all addressing is performed is established. The speed of the response to rapid scanning is determined by the formative delay time (T_{f}) and the statistical delay time (Tₛ).

The above information disclosed in this Background section is only for enhancement of understanding of the background of the invention and therefore it may contain information that does not form the prior art that is already known in this country to a person of ordinary skill in the art.

### SUMMARY OF THE INVENTION

Aspects of the present invention provide a plasma display device that has improved response speed and discharge stability due to reduced temperature dependency of discharge characteristics and provide a method of manufacturing the plasma display device.

According to an embodiment of the present invention, there is provided a plasma display device that includes a plasma display panel comprising an address electrode disposed on a first substrate, a pair of first and second display electrodes disposed on the second substrate and crossing the address electrode, a dielectric layer covering the first and second display electrodes on the second substrate, an MgO protective layer covering the dielectric layer on the second substrate, discharge gases filled between the first and second substrates, a driver that drives the plasma display panel, and a controller that controls the driver so that a sustain pulse width of a sustain period may be 1 to 3.5 μs and wherein the MgO protective layer comprises MgO that has a grain size of 100 to 300 nm.

According to an aspect of the present invention, the sustain pulse width may be 1 to 3.5 μs. According a non-limiting example, the sustain pulse width ranges from 1 to 3.0 μs.

According to an aspect of the present invention, the sustain period is 9 to 25 μs. According to a non-limiting example, the sustain period may be 10 to 25 μs.

According to an aspect of the present invention, the first sustain pulse width of the sustain period is 2 to 7.5 μs. According to a non-limiting example, the first sustain pulse width of the sustain period ranges from 2 to 7 μs.

According to an aspect of the present invention, the discharge gas comprises includes 5 to 30 parts by volume of Xe based on 100 part by volume of Ne. According to a non-limiting example, the discharge gas further includes more than 0 to 70 parts by volume of at least one gas selected from the group of He, Ar, Kr, O₂, N₂, and combinations thereof based on 100 parts by volume of Ne.

According to another embodiment of the present invention, there is provided A plasma display panel comprising at least one pair of first and second display electrodes disposed on a substrate; a dielectric layer covering the at least one pair of first and second display electrodes; and an MgO protective layer covering the dielectric layer, wherein the MgO protective layer comprises MgO that has a grain size of 100 to 300 nm.

According to another embodiment of the present invention, there is provided a method of manufacturing a plasma display device that includes forming a protective layer by MgO deposition, wherein a ratio of H₂/O₂ in the deposition atmosphere is controlled to be within 0.11 to 0.19 during the MgO deposition.

According to another embodiment of the present invention, there is provided a method of manufacturing a plasma display panel of a plasma display device, comprising forming at least one pair of first and second display electrodes on a substrate; forming a dielectric layer to cover the at least one pair of first and second display electrodes; and forming an MgO protective layer on the dielectric layer by MgO deposition, wherein a ratio of H₂/O₂ in a deposition atmosphere ranges from 0.11 to 0.19 during the deposition.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a partial exploded perspective view showing a structure of a plasma display panel according to an embodiment of the present invention;

FIG. 2 is a schematic view showing a plasma display device including the plasma display panel of FIG. 1;

FIG. 3 is a driving waveform of the plasma display device according to FIG. 2;

FIG. 4A is a scanning electron microscope (SEM) photograph of a MgO protective layer showing the grain size of MgO of Sample 11 according to Comparative Example 1;

FIG. 4B is a scanning electron microscope photograph of a MgO protective layer showing the grain size of MgO of Sample 5 according to Example 5;

FIG. 4C is a scanning electron microscope photograph of a MgO protective layer showing the grain size of MgO of Sample 13 according to Comparative Example 2; and

FIG. 5 is a graph showing a statistical delay time (Ts) depending on temperature of plasma display devices according to Samples 5, 6, and 11 to 14.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Aspects of the present invention relate to an MgO protective layer that can improve display quality of a plasma display device.

A plasma display device according to an embodiment of the present invention includes a plasma display panel comprising an address electrode disposed on a first substrate, a pair of first and second display electrodes disposed on the second substrate and crossing the address electrode, a dielectric layer covering the first and second display electrodes on the second substrate, a MgO protective layer covering the dielectric layer on the second substrate, discharge gases filled between the first and second substrates, a driver that drives the plasma display panel, and a controller that controls the driver so that a sustain pulse width of a sustain period may be 1 to 3.5 μs. The MgO protective layer comprises MgO that has a grain size of 100 to 300 nm. According to one embodiment, the grain size of MgO ranges from 100 to 200 nm.

Herein, in general, when it is mentioned that one layer or material is formed on or disposed on or covers a second layer or a second material, it is to be understood that the terms “formed on,” “disposed on” and “covering” are not limited to the one layer being formed directly on the second layer, but may include instances wherein there is an intervening layer or material between the one layer and the second layer.

The sustain pulse width may be 1 to 3.5 μs. According to a non-limiting example, the sustain pulse width ranges from 1 to 3.0 μs. When the sustain pulse width is 1 to 3.5 μs, the high-definition plasma display device has improved uniformity of images due to improved discharge stability.

The sustain period is 9 to 25 μs. According to a non-limiting example, the sustain period may be 10 to 25 μs. When the sustain period is 9 to 25 μs, the high-definition plasma display device has improved uniformity of images due to improved discharge stability.

The first sustain pulse width of the sustain period is 2 to 7.5 μs. According to a non-limiting example, the first sustain pulse width of the sustain period ranges from 2 to 7 μs. When the first sustain pulse width of the sustain period is 2 to 7.5 μs, the high-definition plasma display device has improved uniformity of images due to improved discharge stability.

The discharge gas includes 5 to 30 parts by volume of Xe based on 100 parts by volume of Ne. According to a non-limiting example, the discharge gas includes 7 to 25 parts by volume of Xe based on 100 parts by volume of Ne. When the discharge gas includes Xe and Ne within the above ratio, the discharge initiation voltage is decreased due to an increased ionization ratio of the discharge gas. When the discharge initiation voltage is decreased, the high-definition plasma display device has decreased power consumption and increased brightness.

According to a non-limiting example, the discharge gas further includes more than 0 to 70 parts by volume of at least one gas selected from the group consisting of He, Ar, Kr, O₂, N₂, and combinations thereof based on 100 parts by volume of Ne. According to a non-limiting example, the discharge gas includes 14 to 65 parts by volume of the at least one gas selected from the group consisting of He, Ar, Kr, O₂, N₂, and combinations thereof based on 100 parts by volume of Ne. When the discharge gas includes at least one gas selected from the group consisting of He, Ar, Kr, O₂, N₂, and combinations thereof within the above ratio, the discharge initiation voltage is decreased due to an increased ionization ratio of the discharge gas. When the discharge initiation voltage is decreased, the high-definition plasma display device has decreased power consumption and increased brightness.

An embodiment of the present invention will hereinafter be described in detail with reference to the accompanying drawings. As those skilled in the art would realize, the described embodiments may be modified in various different ways, all without departing from the spirit or scope of the present invention.

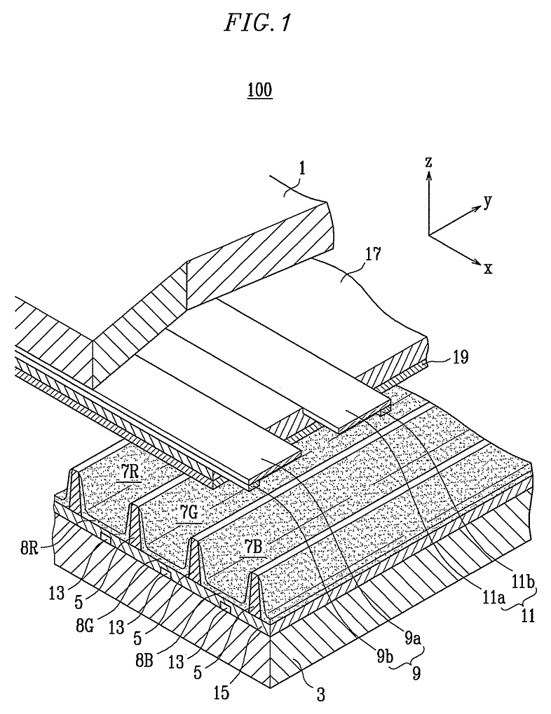

FIG. 1 is a partial exploded perspective view showing the structure of a plasma display panel according to one embodiment. Referring to the drawing, the PDP includes a first substrate 3, a plurality of address electrodes 13 disposed in one direction (a Y direction in the drawing) on the first substrate 3, and a first dielectric layer 15 disposed on the surface of the first substrate 3 covering the address electrodes 13. Barrier ribs 5 are formed on the first dielectric layer 15, and red (R), green (G), and blue (B) phosphor discharge cells 7R, 7G, and 7B are formed between the barrier ribs 5. Red (R), green (G), and blue (B) phosphor layer 8R, 8G, and 8B are disposed in the discharge cells 7R, 7G, and 7B.

The barrier ribs 5 may be formed in any shape as long as their shape can partition the discharge space, and the barrier ribs 5 may have diverse patterns. For example, the barrier ribs 5 may be formed as an open type, such as stripes, or as a closed type, such as a waffle, matrix, or delta shape. As further non-limiting examples, closed-type barrier ribs may be formed such that a horizontal cross-section of the discharge space is a polygon such as a quadrangle, triangle, or pentagon, or a circle or an oval.

Display electrodes 9 and 11, each including a pair of a transparent electrode 9a or 11a and a bus electrode 9b or 11b, are disposed in a direction crossing the address electrodes 13 (an X direction in the drawing) on one surface of a second substrate 1 facing the first substrate 3. Also, a second dielectric layer 17 and an MgO protective layer 19 are disposed on the surface of the second substrate 1 while covering the display electrodes.

The MgO protective layer 19 includes MgO that has a grain size of 100 to 300 nm. According to a non-limiting example, the grain size of MgO ranges from 100 to 200 nm. According to another non-limiting example, the MgO protective layer may include elements selected from the group consisting of a rare earth element, and a combination thereof.

Discharge cells are formed at positions where the address electrodes 13 of the first substrate 3 are crossed by the display electrodes of the second substrate 1.

The discharge cells between the first substrate 3 and the second substrate 1 are filled with a discharge gas. As discussed above, the discharge gas includes 5 to 30 parts by volume of Xe based on 100 parts by volume of Ne. According to a non-limiting example, the discharge gas includes 7 to 25 parts by volume of Xe based on 100 parts by volume of Ne. The discharge gas further includes 0 to 70 parts by volume of at least one gas selected from the group consisting of He, Ar, Kr, O₂, N₂, and combinations thereof based on 100 parts by volume of Ne. According to another non-limiting example, the discharge gas includes 14 to 65 parts by volume of the gas based on 100 parts by volume of Ne.

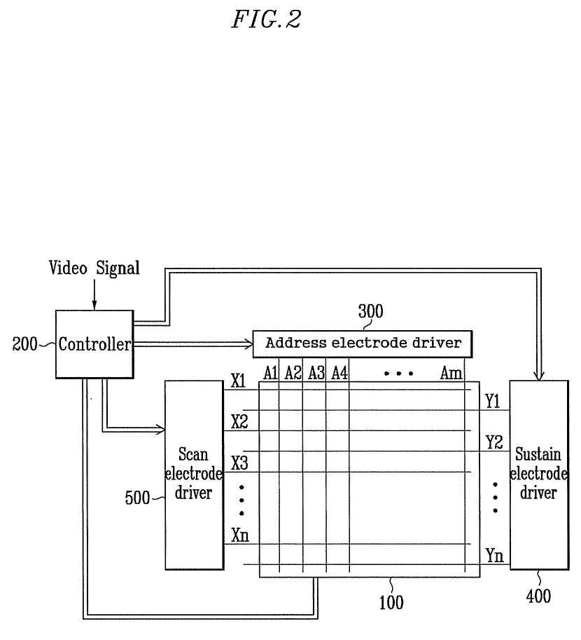

FIG. 2 is a schematic view showing a plasma display device according to an embodiment of the present invention.

As shown in FIG. 2, the plasma display device according to one embodiment of the present invention includes a plasma display panel 100, a controller 200, an address electrode (A) driver 300, a sustain electrode (a second display electrode, X) driver 400, and a scan electrode (a first display electrode, Y) driver 500.

The plasma display panel 100 has the same structure as shown in FIG. 1.

The controller 200 receives video signals from the outside and outputs an address driving control signal, a sustain electrode (X) driving control signal, and a scan electrode (Y) driving control signal. The controller 200 divides one frame into a plurality of subfields, and each subfield is composed of a reset period, an address period, and a sustain period when the subfield is expressed based on temporal driving change.

The address driver 300 receives an address electrode (A) driving control signal from the controller 200, and applies a display data signal for selecting a discharge cell to be displayed to each address electrode.

The sustain electrode driver 400 receives a sustain electrode driving control signal from the controller 200, and applies a driving voltage to the sustain electrodes (X).

The scan electrode driver 500 receives a scan electrode driving control signal from the controller 200 and applies a driving voltage to the scan electrodes (Y).

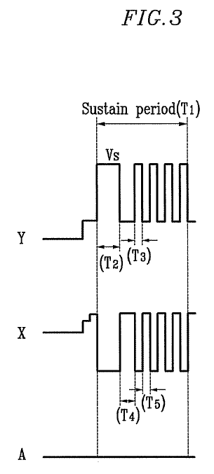

FIG. 3 shows a driving waveform of the plasma display device illustrated in FIG. 2.

As shown in FIG. 3, the first sustain discharge pulse of the Vs voltage at the sustain period (T₁) is applied to the scan electrode (Y) and the sustain electrode (X), alternately. If the wall voltage between the scan electrode (Y) and the sustain electrode (X) is generated, the scan electrode (Y) and the sustain electrode (X) are discharged by the wall voltage and the Vs voltage. Then, the process to apply the scan electrode (Y) with the sustain discharge pulse of the Vs voltage and the process to apply the sustain discharge pulse of the Vs voltage to the sustain electrode (X) are repeated a number of times corresponding to the weighted value indicated by the subfield.

Herein, the first sustain pulse width (T₂) of the scan electrode (Y) or the first sustain discharge pulse width (T₄) of the sustain electrode (X) is 2 to 7.5 μs. According to a non-limiting example, the first sustain pulse width (T₂) of the scan electrode (Y) or the first sustain discharge pulse width (T₄) of the sustain electrode (X) ranges from 2 to 7 μs. The sustain discharge pulse width (T₃) of the scan electrode (Y) or the sustain discharge pulse width (T₅) of the sustain electrode (X) is 1 to 3.5 μs. According to a non-limiting example, the sustain discharge pulse width (T₃) of the scan electrode (Y) or the sustain discharge pulse width (T₅) of the sustain electrode (X) ranges from 1 to 3.0 μs. The sustain period (T₁) is in a range of 9 to 25 μs. According to a non-limiting example, the sustain period (T₁) ranges from 10 to 25 μs.

The present invention provides driving stability to a plasma display device having the driving waveform and the discharge gas. According to a non-limiting example, the grain size of MgO in the MgO protective layer is 100 to 300 nm for improving the driving stability. According to another non-limiting example, the grain size of MgO is 100 to 200 nm.

When the grain size of MgO is less than 100 nm, a black noise and an address misfire may occur due to a decreased response speed at a low temperature. When the grain size of MgO is more than 300 nm, a low discharge at a high temperature may occur due to an increased response speed at a high temperature.

The grain size of MgO can be adjusted by controlling the ratio of H₂/O₂ during the deposition of MgO. According to a non-limiting example, the ratio of H₂/O₂ may be 0.11 to 0.19.

The method of fabricating the plasma display device is well known to persons skilled in this art, so a detailed description thereof will be omitted from this specification. However, the process for forming the MgO protective layer according to one embodiment of the present invention will be described.

The MgO protective layer covers the surface of the dielectric layer covering the display electrodes in the plasma display device to protect the dielectric layer from ionic impact of the discharge gas during the discharge. The MgO protective layer is mainly composed of MgO having sputtering-resistance and a high secondary electron emission coefficient.

The MgO protective layer is preferably formed by physical vapor deposition.

Herein, the grain size of MgO in the MgO protective layer is adjusted by controlling the ratio of H₂/O₂. According to a non-limiting example, the ratio of H₂/O₂ is 0.11 to 0.19.

The method of forming the MgO protective layer by physical vapor deposition is preferably a plasma deposition method. Plasma deposition methods include methods using electron beams, deposition beams, ion plating, and magnetron sputtering.

The following examples illustrate the present invention in more detail. However, it is understood that the present invention is not limited by these examples.

Fabrication of Plasma Display Device

### EXAMPLE 1

Display electrodes having a stripe shape were formed on a soda lime glass substrate in accordance with a conventional process.

A glass paste was coated on the substrate formed with the display electrodes and fired to provide a second dielectric layer.

An MgO protective layer was provided on the second dielectric layer using an ion plating method to provide an second substrate. Herein, the ratio of H₂/O₂ was 0.11 under the deposition atmosphere during the MgO deposition. With the provided second substrate, a plasma display device (Sample 1) was fabricated. The sustain pulse width of a sustain period was 2.1 μs, the sustain period was 15 μs, and the first sustain pulse width of the sustain period was 2.1 μs. Also, the discharge gas included 11 parts by volume of Xe and 35 parts by volume of He based on 100 parts by volume of Ne.

### EXAMPLE 2

A plasma display device (Sample 2) was fabricated in accordance with the same procedure as in Example 1, except that the ratio of H₂/O₂ was 0.12 under the deposition atmosphere during the MgO deposition.

### EXAMPLE 3

A plasma display device (Sample 3) was fabricated in accordance with the same procedure as in Example 1, except that the ratio of H₂/O₂ was 0.13 under the deposition atmosphere during the MgO deposition.

### EXAMPLE 4

A plasma display device (Sample 4) was fabricated in accordance with the same procedure as in Example 1, except that the ratio of H₂/O₂ was 0.14 under the deposition atmosphere during the MgO deposition.

### EXAMPLE 5

A plasma display device (Sample 5) was fabricated in accordance with the same procedure as in Example 1, except that the ratio of H₂/O₂ was 0.15 under the deposition atmosphere during the MgO deposition. A plasma display device (Sample 6) was fabricated in accordance with the same procedure as for Sample 5.

### EXAMPLE 6

A plasma display device (Sample 7) was fabricated in accordance with the same procedure as in Example 1, except that the ratio of H₂/O₂ was 0.16 under the deposition atmosphere during the MgO deposition.

### EXAMPLE 7

A plasma display device (Sample 8) was fabricated in accordance with the same procedure as in Example 1, except that the ratio of H₂/O₂ was 0.17 under the deposition atmosphere during the MgO deposition.

### EXAMPLE 8

A plasma display device (Sample 9) was fabricated in accordance with the same procedure as in Example 1, except that the ratio of H₂/O₂ was 0.18 under the deposition atmosphere during the MgO deposition.

### EXAMPLE 9

A plasma display device (Sample 10) was fabricated in accordance with the same procedure as in Example 1, except that the ratio of H₂/O₂ was 0.19 under the deposition atmosphere during the MgO deposition.

### COMPARATIVE EXAMPLE 1

A plasma display device (Sample 11) was fabricated in accordance with the same procedure as in Example 1, except that the ratio of H₂/O₂ was 0.1 under the deposition atmosphere during the MgO deposition. An additional plasma display device (Sample 12) was fabricated in accordance with the same procedure as for Sample 11.

### COMPARATIVE EXAMPLE 2

A plasma display device (Sample 13) was fabricated in accordance with the same procedure as in Example 1, except that the ratio of H₂/O₂ was 0.2 under the deposition atmosphere during the MgO deposition. An additional plasma display device (Sample 14) was fabricated in accordance with the same procedure as for Sample 13.

Measurement for Grain Size of MgO

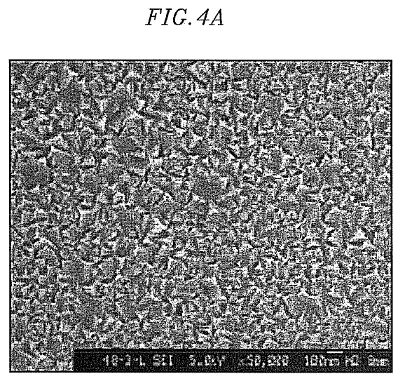

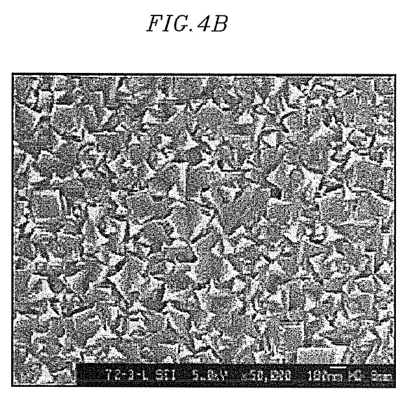

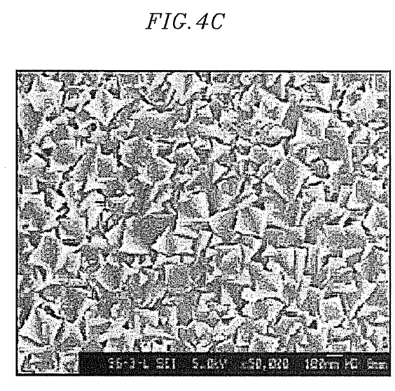

The grain sizes of MgO for the MgO protective layer according to Samples 1 to 14 were examined with a scanning electron microscope (SEM). Scanning electron microscope photographs of Samples 11, 5, and 13 are respectively provided in FIG. 4A to 4C.

Referring to FIGS. 4A to 4C, the grain size of Sample 11 was less than 100 nm, that of Sample 5 was about 200 nm, and that of Sample 13 was more than 300 nm.

Measurement for Response Speed of Plasma Display Device

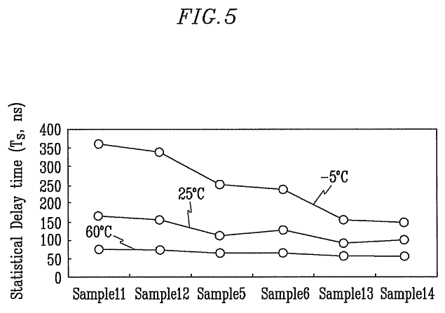

Plasma display devices according to Samples 1 to 14 were driven at a low temperature (−5° C.), room temperature (25° C.), and a high temperature (60° C.) to determine statistical delay times (response speeds), and the results with respect to Samples 5, 6, and 11 to 14 are shown in Table 1 and in FIG. 5. Plasma display devices according to Sample 1 to 4 and 7 to 10 showed similar results to those of Sample 5 or 6.

TABLE 1

| | Statistical delay time (Tₛ, ns) | | |
|---|---|---|---|
| | −5° C. | 25° C. | 60° C. |
| Sample 11 | 358 | 163 | 72 |
| Sample 12 | 336 | 154 | 74 |
| Sample 5 | 250 | 111 | 63 |
| Sample 6 | 235 | 125 | 65 |
| Sample 13 | 153 | 90 | 56 |
| Sample 14 | 147 | 99 | 53 |

Referring to Table 1 and FIG. 5, when the ratio of H₂/O₂ in the atmosphere during deposition of the MgO layer was 0.1, the response speed of the plasma display device containing the MgO layer was slow, so that a black noise or an address misfire occurred. Additionally, when the ratio of H₂/O₂ in the atmosphere during deposition of the MgO layer was 0.2, the response speed at a high temperature of the plasma display device containing the MgO layer was fast, so a low discharge at a high temperature occurred. On the other hand, when the ratio of H₂/O₂ in the atmosphere during deposition of the MgO layer was 0.15, the discharge stability of the plasma display device containing the MgO layer was good, and the response speed was appropriate due to the decrease of the temperature dependency of the response speed. Additionally, the black noise, address misfire, and low discharge at a high temperature did not occur.

The high-definition plasma display device according to one embodiment of the present invention is improved in terms of response speed and discharge stability by adjusting the statistical delay time. The statistical delay time can be adjusted by controlling the ratio of H₂/O₂ in the deposition atmosphere during MgO deposition forming the MgO protective layer of the plasma display device.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display device comprising:
a plasma display panel including
at least one pair of first and second display electrodes disposed on a substrate;
a dielectric layer covering the at least one pair of first and second display electrodes; and
an MgO protective layer covering the dielectric layer;
a driver that drives the plasma display panel; and
a controller that controls the driver so that a sustain pulse width of a sustain period may be 1 to 3.5 μs,
wherein the MgO protective layer comprises MgO that has a grain size of 100 to 300 nm.

2. The plasma display device of claim 1, wherein the grain size of the MgO ranges from 100 to 200 nm.

3. The plasma display device of claim 1, wherein the sustain pulse width is 1 to 3.0 μs.

4. The plasma display device of claim 1, wherein the sustain period is 9 to 25 μs.

5. The plasma display device of claim 4, wherein the sustain period ranges from 10 to 25 μs.

6. The plasma display device of claim 1, wherein the first sustain pulse width of the sustain period is 2 to 7.5 μs.

7. The plasma display device of claim 6, wherein the first sustain pulse width of the sustain period is 2 to 7 μs.

8. The plasma display device of claim 1, wherein the plasma display panel further comprises a discharge gas including 5 to 30 parts by volume of Xe based on 100 parts by volume of Ne.

9. The plasma display device of claim 8, wherein the discharge gas further comprises more than 0 to 70 parts by volume of at least one gas selected from the group consisting of He, Ar, Kr, O₂, N₂, and combinations thereof based on 100 parts by volume of Ne.

10. A method of manufacturing a plasma display device, comprising
forming a protective layer by MgO deposition,
wherein a ratio of H₂/O₂ in a deposition atmosphere ranges from 0.11 to 0.19 during the MgO deposition.
